(19) United States
(12) Patent Application Publication
(10) Pub. No.: US 2015/0043563 A1
(43) Pub. Date: Feb. 12, 2015

(54) METHOD AND APPARATUS FOR DISCOVERING AN ACCESS POINT

(71) Applicant: Huawei Device Co., Ltd., Shenzhen (CN)

(72) Inventors: Xin GUAN, Shenzhen (CN); Ping FANG, Shenzhen (CN); Zhiming DING, Shenzhen (CN)

(73) Assignee: Huawei Device Co., Ltd., Shenzhen (CN)

(21) Appl. No.: 14/523,320

(22) Filed: Oct. 24, 2014

Related U.S. Application Data
(63) Continuation of application No. PCT/CN2013/074476, filed on Apr. 20, 2013.

(30) Foreign Application Priority Data
Apr. 24, 2012 (CN) 201210122903.8

(51) Int. Cl. H04W 48/16; H04W 48/20

(52) U.S. Cl. CPC H04W 48/16; H04W 48/20; H04W 84/12
USPC 370/338

(57) ABSTRACT

A method and apparatus for discovering an access point, where the method includes: sending, by a station, a detection request message to an access point, where the detection request message carries filter condition information that includes transmission service quality of service (QoS) requirement information, and where the transmission service QoS requirement information is used by the access point to determine whether the filter condition is satisfied, and receiving, by the station, a detection response message sent by the access point when the access point determines that the filter condition is satisfied.

### CROSS-REFERENCE TO RELATED APPLICATIONS

This application is a continuation of International Application No. PCT/CN2013/074476, filed on Apr. 20, 2013, which claims priority to Chinese Patent Application No. 201210122903.8, filed on Apr. 24, 2012, both of which are hereby incorporated by reference in their entireties.

### FIELD OF THE INVENTION

The present invention relates to the field of communications, and in particular, to a method and apparatus for discovering an access point.

### BACKGROUND OF THE INVENTION

A wireless fidelity (Wireless Fidelity, WiFi) network is usually formed by one access point (AP) and multiple stations (STA), where one AP can provide an access service for multiple STAs. To enable an STA to quickly establish a connection with an AP, the IEEE formed an IEEE 802.11ai project group, where the project group aimed at increasing the speed of connecting an STA and an AP. Quickly connecting STAs and an AP are implemented on the premise on how the STAs quickly discover an effective AP.

In an existing method for an STA to discover an AP, the STA sends a detection request message to the AP, where the detection request message is used to detect an AP that can provide an access service, after receiving the detection request message, the AP sends a detection response message to the STA, and the STA provides a selectable WiFi network list for a user according to the received detection response message. In the foregoing method, only the AP that can provide the access service is provided for the user, a requirement of a service of the STA, which is imposed on the quality of a network, is not taken into consideration, and when the user selects a discovered WiFi network, a transmission service quality of service (QoS) requirement is imposed on the AP. At this time, a problem that the WiFi network is currently overloaded, and therefore the WiFi network cannot satisfy a requirement of the user on the current network may occur. For example, if the STA needs to run online video player software, and the STA detects an AP that can provide an access service and provides a WiFi network list for the user for selection, and after the user selects to perform access, it is discovered that a bandwidth of the WiFi network neither supports playing of an online video nor satisfies a transmission service QoS requirement. At this time, the STA needs to search for an effective AP again, namely, an AP that can satisfy the quality of service required by the STA, which definitely increases a delay that the STA detects an effective AP. Therefore, an existing method for detecting an AP is not helpful to implement a quick connection between STAs and an AP.

### SUMMARY OF THE INVENTION

Embodiments of the present invention provide a method and apparatus for discovering an access point.

In one embodiment of the present invention, there is provided a method for discovering an access point including: sending, by a station, a detection request message to an access point, where the detection request message carries filter condition information that includes transmission service quality of service (QoS) requirement information, and where the transmission service QoS requirement information is used by the access point to determine whether the filter condition is satisfied; and receiving, by the station, a detection response message sent by the access point when the access point determines that the filter condition is satisfied.

In another embodiment of the present invention, there is provided a method for discovering an access point including: receiving, by the access point, a detection request message sent by a station, where the detection request message carries filter condition information that includes transmission service quality of service (QoS) requirement information; determining, by the access point, whether the filter condition is satisfied based on the transmission service QoS requirement information; and sending a detection response message to the station when the access point determines that the filter condition is satisfied.

In yet another embodiment of the present invention, there is provided a station for discovering an access point including: a sending unit configured to send a detection request message, where the detection request message carries a filter condition, the filter condition includes transmission service quality of service (QoS) requirement information, and the transmission service QoS requirement information is used by the access point to determine whether the filter condition is satisfied; and a receiving unit, configured to receive a detection response message sent by the access point when the access point determines that the filter condition is satisfied.

In yet another embodiment of the present invention, there is provided an access point including: a receiving unit configured to receive a detection request message sent by a station, where the detection request message carries a filter condition information that includes transmission service quality of service (QoS) requirement information; and a determining unit configured to determine whether the filter condition is satisfied based on the transmission service QoS requirement information; and a response unit configured to send a detection response message to the station when the determining unit determines that the filter condition is satisfied.

In at least some embodiments of the present invention, a filter condition of QoS requirement information of a station may be carried in a detection request message sent to an AP, namely, an STA notifies the AP of the QoS requirement information before accessing a wireless WiFi network, and the AP uses whether the AP satisfies the QoS requirement information as one of requirements for determining whether the filter condition is satisfied, and sends a detection response message only when the QoS requirement information is satisfied.

In this manner, at least some embodiments of the present invention may avoid the problem that because a network cannot satisfy a requirement, the STA continues to discover, after accessing the network, another effective network, thereby greatly reducing a delay of connecting the STA to an effective WiFi network. This increases the speed of connecting the STA to the effective WiFi network, and helps to implements a quick connection between STAs and an AP.

### BRIEF DESCRIPTION OF THE DRAWINGS

FIG. 1 is a flow chart of a method for discovering an access point according to an embodiment of the present invention;

FIG. 2 is a flow chart of a method for an STA to send a detection request message to an AP according to an embodiment of the present invention;

FIG. 3 is a schematic structural diagram of a frame of a transmission service QoS requirement information element according to an embodiment of the present invention;

FIG. 4 is a flow chart of another method for discovering an access point according to an embodiment of the present invention;

FIG. 5 is a flow chart of a method for an AP to determine whether a filter condition is satisfied according to an embodiment of the present invention;

FIG. 6 is a schematic structural diagram of a station for discovering an access point according to an embodiment of the present invention;

FIG. 7 is a schematic structural diagram of a sending unit in a station for discovering an access point according to an embodiment of the present invention;

FIG. 8 is a schematic structural diagram of an access point according to an embodiment of the present invention; and

FIG. 9 is a schematic structural diagram of a determining unit in an access point according to an embodiment of the present invention.

### DETAILED DESCRIPTION OF THE EMBODIMENTS

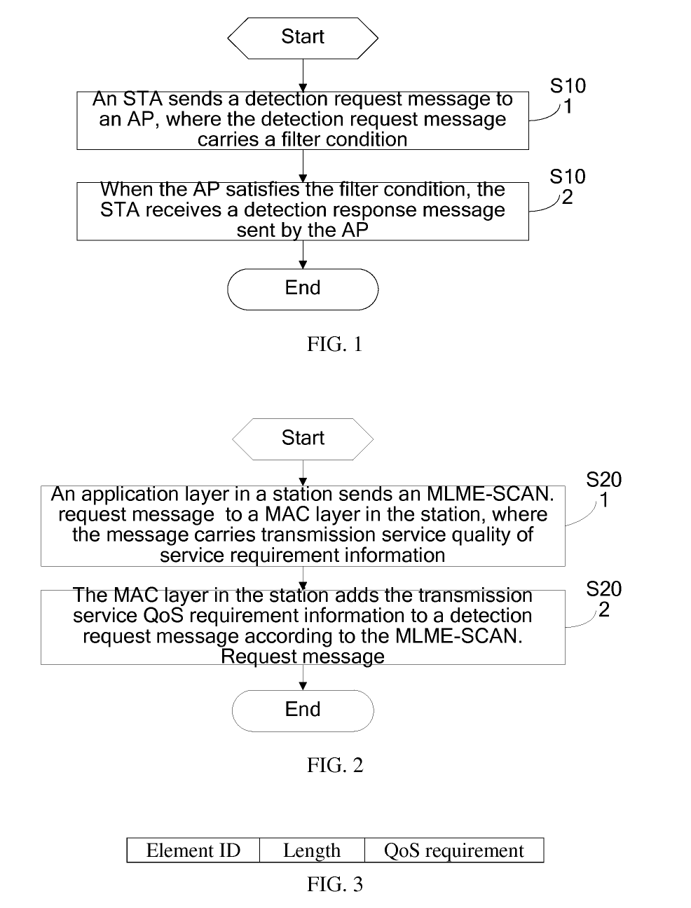

A method for discovering an access point disclosed in an embodiment of the present invention may be applied to the following scenario: An STA in a state of being connected to no network is connected to a WiFi network, and a quick connection between the STA and the WiFi network needs to be implemented, or the STA is handed over from one WiFi network to another WiFi network, and a quick handover needs to be implemented, so as to ensure continuity of a user service. As shown in FIG. 1, the method includes:

S101: An STA sends a detection request message to the AP, where the detection request message carries a filter condition, and the filter condition includes transmission service quality of service requirement information, and the filter condition is used by the access point to determine whether the filter condition is satisfied.

The STA is a station in a network, and in an actual application, may be a mobile communication terminal, and may also be an electronic device such as a personal computer.

The detection request message is used by the STA to detect an existing AP. What is different from the prior art is that, the filter condition carried in the detection request message in this embodiment of the present invention, in addition to an existing condition, further includes transmission service quality of service requirement information of the STA, namely, transmission service QoS requirement information, where the transmission service QoS requirement information is used to indicate a requirement of a transmission service of the STA, where the requirement of the transmission service of the STA is imposed on the quality of a network, and different transmission services emphasize different QoS requirements. For example, a voice service is sensitive to a transmission delay limit, and a video service has a high requirement on a channel remaining bandwidth limit. Therefore, the transmission service QoS requirement information in this embodiment may include at least one of the following parameters and a value of the parameter: a size of a nominal medium access control service data unit, a size of a maximum medium access control service data unit, a minimum service interval, a maximum service interval, a standstill interval, a suspension interval, service start time, an average data rate, a maximum data rate, a size of a burst, a delay limit, a minimum physical layer rate, a remaining bandwidth limit, and medium time.

It should be noted that, the filter condition in the detection request message may, in addition to the transmission service QoS requirement information, further include other information, for example, a service set identifier (SSID), and a basic service set identifier (BSSID).

S102: When the AP satisfies the filter condition, the STA receives a detection response message sent by the AP.

The STA usually sends the detection request message in a broadcast manner, APs around the STA all receive the detection request message if they can, and the AP also sends the detection response message in a broadcast manner.

It should be noted herein that, the filter condition may include multiple conditions, namely, the AP, in addition to satisfying the transmission service QoS requirement information, further needs to satisfy other conditions, for example, needs to satisfy requirements of conditions such as the service set identifier (SSID) and the basic service set identifier (BSSID), where technical measures in the prior art may be adopted for a process of determining whether other conditions are satisfied, which are not described herein again.

Further, as shown in FIG. 2, in this embodiment, before the STA sends the detection request message to the AP, the method may further include:

S201: An application layer in the STA sends a medium access control sublayer management entity-scan request (medium access control sublayer management entity-scan. request, MLME-SCAN. request) message to a medium access control (medium access control, MAC) layer in the STA, where the message carries the transmission service quality of service requirement information.

It should be noted that, the MLME-SCAN. Request message, in addition to carrying the transmission service QoS requirement information, usually further includes ScanType information. The information is used to indicate a type of a detected AP, and includes active detection and passive detection. A detection method in this embodiment is used in the case of the active detection, namely, the STA actively sends a detection message to the AP, while the case of the passive detection does not belong to the scope of the present invention, which is not described herein.

S202: The MAC layer adds the transmission service QoS requirement information to the detection request message according to the MLME-SCAN. Request message.

A structure of a frame of the transmission service QoS requirement information may be shown in FIG. 3, and includes:

an ID number (Element ID) of the transmission service QoS requirement information, a length (Length) of the transmission service QoS requirement information, and a preset requirement of the transmission service quality of service (QoS requirement), where each of the foregoing items may occupy a length of one byte, and the preset value of the parameter of the transmission service quality of service is determined according to different transmission service QoS requirement information.

The method for an STA to send a detection request message, which carries transmission service QoS requirement information to an AP, as shown in FIG. 2, is implemented by a physical layer and an upper layer of the physical layer of the STA, so as to facilitate implementation of hardware.

With the method for discovering an access point in this embodiment, a filter condition including transmission service QoS requirement information of an STA is carried in a detection request message sent by the STA to an AP, and when the AP satisfies the filter condition, the STA receives detection response message. No matter the STA discovers a WiFi network in the case that the STA is connected to no network, or the STA is handed over from a current WiFi network to another WiFi network, with the method described in this embodiment, it is ensured that a WiFi network provided for a user is an effective network, namely, a network that can satisfy the transmission service QoS requirement information of the STA, thereby avoiding that because the quality of a wireless network which the STA has accessed cannot satisfy a requirement, the STA re-detects a new effective network, and increasing the speed of connecting the STA and an effective AP.

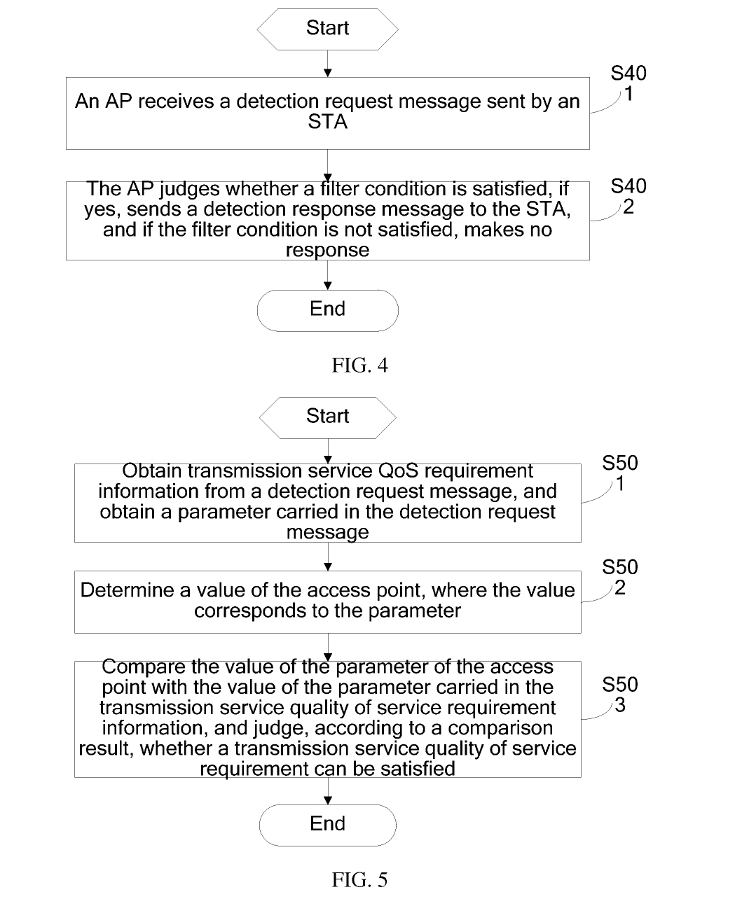

An embodiment of the present invention discloses another method for discovering an access point. As shown in FIG. 4, the method includes:

S401: The access point receives a detection request message sent by a station, where the detection request message carries a filter condition, and the filter condition includes transmission service quality of service requirement information.

S402: The access point determines whether the filter condition is satisfied, if yes, sends a detection response message to the station, and if the filter condition is not satisfied, makes no response.

Further, a method for the AP to determine whether the filter condition is satisfied may be shown in FIG. 5, and may specifically include:

S501: Obtain the transmission service QoS requirement information from the filter condition, and obtain a parameter and a value of the parameter that are carried in the transmission service quality of service requirement information.

S502: Determine a value of the access point, where the value corresponds to the parameter.

The data of the access point, which corresponds to the parameter, may be determined according to a load situation of the AP. The load situation of the AP refers to a situation that the AP provides network traffic for the STA. Usually, the load situation directly reflects the quality and a state of a WiFi network where the AP is located. In other words, correspondence exists between the load situation and a quality parameter such as a network bandwidth that can be provided by the AP, or a network delay. For example, the lighter a load of the AP is, the larger a current network bandwidth can be provided is, and the smaller a network delay generated by the AP is; otherwise, the heavier a load of the AP is, the smaller the current network bandwidth can be provided by the AP is, and the larger the network delay generated by the AP is.

It should be noted that, the load of the AP is not only related to the number of STAs that currently access the AP, and but also related to network traffic provided by the AP to an accessing STA. The larger the number of accessing STAs is, the heavier the load is. The larger the network traffic provided by the AP to the accessing STA, the heavier the load is. For example, when more current access types of the AP are high-priority service types (voice and video), the load is heavier.

The AP may determine, according to a current load situation of the AP, a value that corresponds to the parameter and the value of the parameter that are carried in the transmission service QoS requirement information. For example, the transmission service QoS requirement information is a value of a minimum physical layer rate, where the value is required by a transmission service, the AP determines, according to the load situation, a value of a minimum physical layer rate that can be provided by the AP currently; and if the transmission service QoS requirement information is a value of a transmission service delay limit, the AP determines, according to the load situation, a value of a delay limit generated by a transmission service of the AP.

S503: Compare the value of the parameter of the access point with the value of the parameter carried in the transmission service quality of service requirement information, and determine, according to a comparison result, whether a transmission service quality of service requirement can be satisfied.

For example, the value of the minimum physical layer rate that can be provided by the AP is compared with the value of the minimum physical layer rate carried in the transmission service QoS requirement information of the STA, and if the value of the minimum physical layer rate that can be provided by the AP is larger than the value of the minimum physical layer rate carried in the transmission service QoS requirement information of the STA, the AP determines that the transmission service quality of service requirement of the STA can be satisfied; alternatively, the value of the delay limit generated by the transmission service of the AP is compared with the value of the delay limit carried in the transmission service QoS requirement information of the STA, and if the value of the delay limit generated by the transmission service of the AP is smaller than the value of the transmission service delay limit of the STA, it is determined that the AP can satisfy the transmission service quality of service requirement of the STA.

As described in the foregoing, the transmission service quality of service requirement information may include multiple types of different contents, and therefore, a comparison rule between the value determined by the AP and the value of the parameter, which is carried in the transmission service quality of service requirement information, is also different. However, no matter which type of transmission service quality of service requirement information is, the AP can determine, according to the load situation of the AP, whether it is satisfied.

The foregoing method for the AP to determine, according to the load situation of the AP, whether the AP satisfies a requirement is merely an exemplary method in this embodiment, and other methods for determining whether the AP satisfies the transmission service quality of service requirement information of the STA shall all fall within the protection scope of the present invention.

With the method for discovering an access point in this embodiment, an AP responds to a detection request message only when the AP satisfies a QoS requirement of an STA, no matter the STA discovers a WiFi network in the case that the STA is connected to no network, or the STA is handed over from a current WiFi network to another WiFi network, with the method described in this embodiment, it is ensured that a WiFi network provided for a user is an effective network, namely, a network that can satisfy transmission service QoS requirement information of the STA, thereby avoiding that because the quality of a wireless network which the STA has accessed cannot satisfy a requirement, the STA re-detects a new effective network, and increasing the speed of connecting the STA and an effective AP; and moreover, an AP that does not satisfy the transmission service QoS requirement information of the STA does not respond to the detection request message, thereby reducing the number of unnecessary detection response messages of the AP, and saving a channel resource.

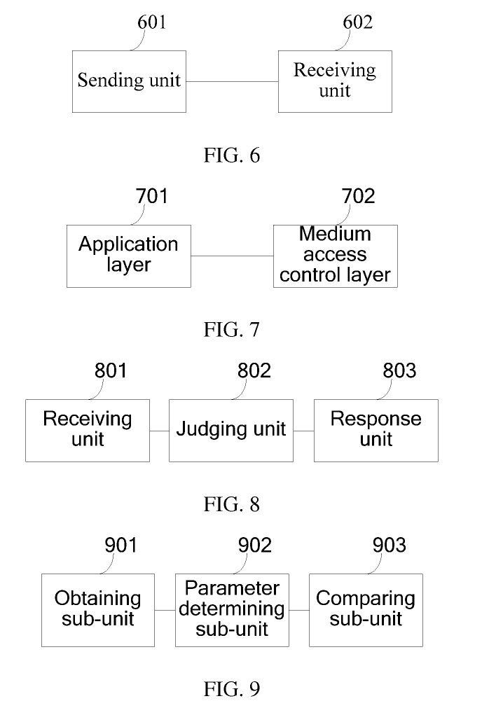

Correspondingly to the foregoing method, an embodiment of the present invention further discloses a station for discovering an access point. As shown in FIG. 6, the station includes:

a sending unit 601, configured to send a detection request message, where the detection request message carries a filter condition, the filter condition includes transmission service quality of service requirement information, and the filter condition is used by an access point to determine whether the filter condition is satisfied; and

a receiving unit 602, configured to: when the access point satisfies the filter condition, receive a detection response message sent by the access point.

Further, as shown in FIG. 7, the station may further include:

an application layer 701, configured to send a medium access control sublayer management entity-scan request message to a medium access control layer, where the message carries the transmission service quality of service requirement information; and

the medium access control layer 702, configured to add the transmission service quality of service requirement information to the detection request message.

With the station for discovering an access point in this embodiment, transmission service QoS requirement information is notified to an AP during detection, so that an AP obtained through detection is an effective AP, and a problem of re-detection is not caused because an accessed AP cannot satisfy a requirement, thereby increasing the speed of connecting an STA and an effective AP.

An embodiment of the present invention discloses an access point. As shown in FIG. 8, the access point includes:

a receiving unit 801, configured to receive a detection request message that carries a filter condition, where the filter condition includes transmission service quality of service requirement information, and the detection request message is sent by a station; and

a determining (judging) unit 802, configured to determine, according to the filter condition, whether the filter condition is satisfied; and

a response unit 803, configured to: when the filter condition is satisfied, send a detection response message to the station.

As shown in FIG. 9, the determining unit may further include:

an obtaining sub-unit 901, configured to obtain the transmission service quality of service requirement information from the detection request message;

a parameter determining sub-unit 902, configured to determine, according to a load situation of the parameter determining sub-unit, a value related to a value of a parameter, where the value of the parameter is carried in the transmission service quality of service requirement information; and

a comparing sub-unit 903, configured to compare the value with the value of the parameter, where the value of the parameter is carried in the transmission service quality of service requirement information, and determine, according to a comparison result, whether a transmission service quality of service requirement of the station can be satisfied.

The access point described in this embodiment may be set at a WiFi network side where the AP is located, and is used by the AP to respond to a detection request message of an STA end. What is different from the prior art is that, the access point described in this embodiment includes a determining unit that can determine whether a filter condition including transmission service QoS requirement information that is notified by an STA is satisfied, and makes a response to the STA only when the filter condition is satisfied.

The access point described in this embodiment together with the station described in the foregoing embodiment can implement a quick connection between a terminal and an AP, and moreover, a channel resource occupied by the AP to respond to the STA may be saved.

When the functions are implemented in the form of a software functional unit and sold or used as an independent product, the functions may be stored in a computer-readable storage medium. Based on such an understanding, the technical solutions of the present invention essentially, or the part contributing to the prior art may be implemented in the form of a software product. The software product is stored in a storage medium, and includes several instructions for instructing a computer device (which may be a personal computer, a server, or a network device) to perform all or part of the steps of the methods provided in the embodiments of the present invention. The storage medium includes: any medium that can store program codes, such as a USB flash disk, a removable hard disk, a read-only memory (ROM, Read-Only Memory), a random access memory (RAM, Random Access Memory), a magnetic disk, or an optical disk.

Embodiments in the present invention are described progressively, in that each embodiment describes only a difference from other embodiments. For the same or similar part among all embodiments, reference may be made to the relevant part.

Although the present invention has been described with reference to specific features and embodiments thereof, it should be understood by persons skilled in the art that various changes and substitutions can be made thereto without departing from the spirit and scope of the invention as defined by the following claims.

What is claimed is:

1. A method for discovering an access point performed by a station, comprising:
sending, by a station, a detection request message to an access point, wherein the detection request message carries filter condition information that comprises transmission service quality of service (QoS) requirement information, and wherein the transmission service QoS requirement information is used by the access point to determine whether the filter condition is satisfied; and
receiving, by the station, a detection response message sent by the access point when the access point determines that the filter condition is satisfied.

2. The method according to claim 1, before the sending the detection request message to the access point, further comprising:
sending, by an application layer in the station, a medium access control sublayer management entity-scan request message to a medium access control layer in the station, wherein the medium access control sublayer management entity-scan request message carries the transmission QoS requirement information; and
adding, by the medium access control layer in the station, the transmission service QoS requirement information to the detection request message.

3. The method according to claim 1, wherein the transmission service QoS requirement information comprises at least one of the following parameters and a value of the parameter:
a size of a nominal medium access control service data unit, a size of a maximum medium access control service data unit, a minimum service interval, a maximum service interval, a standstill interval, a suspension interval, service start time, an average data rate, a maximum data rate, a size of a burst, a delay limit, a minimum physical layer rate, a remaining bandwidth limit, and medium time that are required by the transmission service.

4. The method according to claim 2, wherein the transmission service QoS requirement information comprises at least one of the following parameters and a value of the parameter:
a size of a nominal medium access control service data unit, a size of a maximum medium access control service data unit, a minimum service interval, a maximum service interval, a standstill interval, a suspension interval, service start time, an average data rate, a maximum data rate, a size of a burst, a delay limit, a minimum physical layer rate, a remaining bandwidth limit, and medium time that are required by the transmission service.

5. A method for discovering an access point performed by an access point, comprising:
receiving, by an access point, a detection request message sent by a station, wherein the detection request message carries filter condition information that comprises transmission service quality of service (QoS) requirement information;
determining, by the access point, whether the filter condition is satisfied based on the transmission service QoS requirement information; and
sending, by the access point, a detection response message to the station when the access point determines that the filter condition is satisfied.

6. The method according to claim 5, wherein the determining whether the filter condition is satisfied comprises:
obtaining, by the access point, the transmission service QoS requirement information from the filter condition, and obtaining a parameter and a value of the parameter that are carried in the transmission service QoS requirement information;
determining a value of the access point, wherein the value corresponds to the parameter; and
comparing the value of the parameter of the access point with the value of the parameter, wherein the value of the parameter is carried in the transmission service QoS requirement information, and determining, according to a comparison result, whether a transmission service QoS requirement of the station can be satisfied.

7. A station for discovering an access point, comprising:
a sending unit configured to send a detection request message, wherein the detection request message carries filter condition information that comprises transmission service quality of service (QoS) requirement information, and the transmission service QoS requirement information is used by the access point to determine whether the filter condition is satisfied; and
a receiving unit configured to receive a detection response message sent by the access point when the access point determines that the filter condition is satisfied.

8. The station according to claim 7, further comprising:
an application layer, configured to send a medium access control sublayer management entity-scan request message to a medium access control layer, wherein the message carries the transmission service QoS requirement information; and
the medium access control layer, configured to add the transmission service QoS requirement information to the detection request message.

9. An access point, comprising:
a receiving unit configured to receive a detection request message sent by a station, wherein the detection request message carries filter condition information that comprises transmission service quality of service (QoS) requirement information;
a determining unit configured to determine whether the filter condition is satisfied based on the transmission service QoS requirement information; and
a response unit configured to send a detection response message to the station when the determining unit determines that the filter condition is satisfied.

10. The access point according to claim 8, wherein the determining unit comprises:
an obtaining sub-unit, configured to obtain the transmission service QoS requirement information from the detection request message;
a parameter determining sub-unit configured to determine, according to a load situation of the parameter determining sub-unit, a value related to a value of a parameter, wherein the value of the parameter is carried in the transmission service QoS requirement information; and
a comparing sub-unit configured to compare the value with the value of the parameter, wherein the value of the parameter is carried in the transmission service QoS requirement information, and determine, according to a comparison result, whether a transmission service QoS requirement of the station can be satisfied.
